(19) United States
(12) Patent Application Publication
(10) Pub. No.: US 2014/0379605 A1
(43) Pub. Date: Dec. 25, 2014

(54) AUTOMATIC SUPPLY-CHAIN MONITORING

(71) Applicant: Controlant ehf., Reykjavik (IS)

(72) Inventors: Gisli Herjolfsson, Kopavogur (IS); Erlingur Brynjulfsson, Reykjavik (IS)

(21) Appl. No.: 14/375,768

(22) PCT Filed: Jan. 30, 2013
(86) PCT No.: PCT/IS2013/050001

§ 371 Date: Jul. 30, 2014

(30) Foreign Application Priority Data
Jan. 30, 2012 (IS) 050029
Sep. 11, 2012 (IS) 050038

(51) Int. Cl. G06Q 10/08

(52) U.S. Cl. CPC G06Q 10/0833
USPC 705/333

(57) ABSTRACT

The present invention provides a system and method for automatic valuation of the quality of a shipment process in terms of environment conditions and in terms of logistics. The system and method performs automatic statistical analysis on the collected data to facilitate identification of anomalies or inefficiencies in the process. At least one or more information on the shipment is used when shipment is closed.

### FIELD OF THE INVENTION

The present invention relates to a fully automatic method and a system for supply-chain monitoring of shipments.

### BACKGROUND OF THE INVENTION

Traditional environmental variable monitoring solutions for distribution networks rely on offline loggers which needs to be connected to a computer before accumulated data can be utilized for practical uses. Other recent solutions rely on wireless communication.

In many industries environmental conditions, such as temperature, humidity etc., is the most important external factor to the product being produced and distributed. Knowing the condition of a product throughout a distribution network, from origin to destination/production to resale, is a key issue to be able to ensure a quality product is being delivered to end consumer. Furthermore the value of knowing that a shipment or a process has been delivered with good quality can have a great positive impact on a company from a logistic point of view, where more overview current shipment status and quality assurance aids operators and business owners to make decisions.

A system for chain monitoring is shown on FIG. 1. The system has been implemented by owner of this patent application.

U.S. Pat. No. 7,711,654 describes systems and methods for collecting data concerning a supply chain and perform statistical analysis on the collected data to facilitate identification of anomalies or inefficiencies in the process. One method disclosed involves storing, in memory accessible to at least one processor, an electronic copy of an advanced shipping notification (ASN) that was transmitted from a shipping location to a receiving location in advance of shipping at least one item there between, and also storing, in memory accessible to the at least one processor, data reflecting at least one determined value of at least one monitored aspect of the shipment between the shipping location and the receiving location. The at least one processor uses at least some information from the ASN stored in memory, with at least some of the data stored in memory, to generate at least one report involving the at least one determined value.

Several methods and systems have been disclosed, such as in U.S. 2008/0291033 and U.S. 2008/0252428 using wireless environmental monitors and GPS technology to monitor a shipment, optimizing the transport route and closing a shipment that reaches it's destination without a problem.

### SUMMARY OF THE INVENTION

It is an object of the present invention to provide an improved system and method to perform real-time monitoring of numerous shipments at once for automatic analysis and “closure” of a shipment in a distribution network where conditions during shipment such as environment conditions and user specified parameters are monitored. The system performs automatic analysis on the collected data to facilitate identification of anomalies or inefficiencies in the shipment process.

The problem with prior art methods is that they solve the task of monitoring shipments shipment but they don't anticipate the problems of monitoring and closing a plurality of shipments in a large shipment network. The present invention uses automatic communication of data between wireless loggers (sensors), transceivers and a centralized database to collect information, verify if a shipment is at a destination location, comparing data from wireless loggers to the user selected reference values in the centralized database and closing of the shipment is performed in an automatic manner. The present invention also uses event creation to inform the system when a wireless logger starts to communicate with a transceiver at a new location by generating data with this information and communicating this data to the wireless logger if the new locations is predefined as a location in the centralized database for this particular shipment. In this manner, each shipment is automatically monitored from the initiation of the shipment and until it is automatically closed, all data is stored in the centralized database and then used for analyzing and closing the shipment. By creating a special event when a wireless logger starts to communicate with a transceiver at a new location, redundant communication and analysis of data is prevented as the centralized database does nothing if such an event is not communicated to the system. This allows users to monitor more shipments and service more clients. By making the system “event driven” in terms of knowing when logger enters a new location, shipments can be automatically monitored in a larger scale, while still offering redundancy by being able to monitor shipments in a centralized manner. It is essential to limit processing in order to provide a centralized system, using a shared infrastructure, such as disclosed in this patent, to be able to service multiple customers shipping multiple shipments where number of both customers and shipments for each customer can grow immensely.

The present invention discloses storing, in a centralized system, information on a shipment. Upon arrival to a destination the shipment is automatically analyzed when a wireless logger with a certain ID number comes in reach of a transceiver, for wireless communication, with a certain location ID and determined to be “closed” if a user or system specified criteria for the shipment (environment conditions, time limit etc.) is met. At least one or more information on the shipment is used by the closure process when shipment is closed.

In a distribution network process, where a product is being sent between location A and location 8, a shipment can be automatically “closed”—with the possibility of automatic detailed analysis—by keeping track of shipment destination along with other related parameters in a centralized system. Once messages of on which location a wireless logger is currently on (or in the vicinity of) match the shipment definition of the destination location, the system can automatically delivers, analyses and closes the shipment, and then informs the user according to his preference. Furthermore, the process of “starting or initiating” a shipment in the system of the present invention can be fully automated and integrated to ordering systems of distributors. It can also be done manually, e.g. in a web-based interface, in desktop software, in a mobile application and through a web-service.

The system does not require the presence of transceivers while in transportation. That, however, may provide more real-time information along with location information. The fact that it is not necessary to make the system work makes it more flexible and offers more types of users the possibility to use such a system.

The system and method of the present invention keeps track of locations in the system, no matter which customer owns each location. On each location there may be one and up to a number of transceivers, which are used to issue location events into the centralized system. These location events are used to initialize an analysis process which then leads to a decision in the centralized database on whether to “close” a shipment or not.

The closure process is automatic, where transceivers having a function for the location definition issue events when the wireless logger arrives at the destination location. Once the system has analyzed the data for anomalies (i.e. environmental conditions) the system either decides to close the shipments, with or without comments, or not. If not—the user is able to take action according to the reason for the shipment not to be closed.

In a first aspect of the present invention a system is provided to maintain real-time monitoring of numerous shipments at once. The system comprises a network of transceivers, where each transceiver is assigned to a location and one or more wireless loggers is assigned to each shipment. The wireless loggers comprises a wireless communication module, a processor, a sensor to monitor conditions during the shipment and generate measurement data, and memory to store the measurement data. The system further comprises a centralized database system to receive and store measurement data, store information to define locations and transceivers associated to said locations within the said system, and store user selected reference values for said conditions during transport of the shipment. Each transceiver communicates with one or more wireless loggers and where automatic communication of data between wireless loggers, transceivers and centralized database is performed by a communication protocol. Each shipment is closed by performing the following steps: 1) verification in the centralized database that a wireless logger in said shipment has communicated with a transceiver at a destination location, 2) comparing data sent from wireless loggers through a transceiver before, during or after transportation to the user selected reference values in the centralized database for the shipment, 3) determining if the data for the shipment falls within the predetermined reference values for the shipment, 4) update shipment information with information from the analysis process and 5) closing shipment if the data for the shipment falls within the predetermined reference values for the shipment. The steps of closing a shipment are performed automatically and the system further comprises an event which is created when a wireless logger starts to communicate with a transceiver at a new location other than its previous location.

In a second aspect of the present invention a method is provided for use in a system for automatic supply-chain monitoring during shipment of at least one item. The method comprising the steps of initiating a shipment by associating at least one wireless data-logger with the at least one item to be transported from a shipping location to a receiving location and then creating first data and storing in an “on-line” database for the one or more item is shipped from shipping location. The first data comprises the following, but is not limited to an identification of the specific shipment, identification of one or more wireless data-logger associated to the shipment and a reference to the receiving location of the shipment. Thereafter the method involves collecting second data during the shipment by the one or more wireless data-loggers and a verification of arrival of shipment at the receiving location by confirming the presence of the at least one wireless data-logger at the receiving location and creating a third data relating to confirmation of arrival of shipment at the receiving location. The next step is a transfer of the second and third data to the centralised database by a transceiver unit, analysing the data by comparing the first data to the second and third data and finally deciding if the shipment can be closed based on the data analysis. The system further comprises an event, which is created when a wireless logger starts to communicate with a transceiver at a location other than its previous location. The centralised database uses the event to determine on which location the logger is present based on the date the event contains.

In a third aspect of the present invention a method is provided for use in a system for automatic supply-chain monitoring during shipment of at least one item. The method comprising the steps of initiating a shipment by associating at least one wireless data-logger with the at least one item to be transported from a shipping location to a receiving location and then creating first data and storing in an “on-line” database for the one or more item is shipped from shipping location. The first data comprises the following, but is not limited to an identification of the specific shipment, identification of one or more wireless data-logger associated to the shipment and a reference to the receiving location of the shipment. Thereafter the method involves collecting second data during the shipment by the one or more wireless data-loggers and a verification of arrival of shipment at the receiving location by confirming the presence of the at least one wireless data-logger at the receiving location and creating a third data relating to confirmation of arrival of shipment at the receiving location. The next step is a transfer of the second and third data to the centralised database by a transceiver unit, analysing the data by comparing the first data to the second and third data and finally deciding if the shipment can be closed based on the data analysis.

In a fourth aspect of the present invention a system is provided for automatic supply-chain monitoring during shipment of at least one item. The system comprises at least one wireless data-logger is associated with the at least one item to be transported from a shipping location to a receiving location for initiating a shipment and an “on-line” database for storing first data created for the shipment of the one or more item is shipped from shipping location. The first data comprises the following, but is not limited to an identification of the specific shipment, identification of one or more wireless data-logger associated to the shipment and a reference to the receiving location of the shipment. The one or more wireless data-loggers collect second data during the shipment and a transceiver unit or the one or more wireless data-logger confirms the arrival of shipment at the receiving location and creating a third data relating to the confirmation.

The second and third data are transferred from the one or more wireless data-loggers to the centralised data base by the transceiver unit where the data is analysed by comparing the first data to the second and third data before the shipment can be closed.

The object of the invention is achieved by the features of the claims and/or the following aspects and embodiments of the present invention.

### DESCRIPTION OF THE INVENTION

The following embodiments and definitions relate to both, method, system and devices of the invention.

In an embodiment of the present invention the transceiver creates the event and generates data comprising this information, storing a new location ID in the memory of the wireless logger and communicating the event to the centralized database.

In an embodiment of the present invention the event is created when in the centralized database when a wireless logger starts to communicate to a transceiver at a location other than its previous location, said event being created as a result of a data comparison and/or data analysis determining if the shipment is at a destination location.

In an embodiment of the present invention the network of transceivers comprises transceivers located at two or more locations; selected from a shipping location, an intermediate location and a receiving location.

In an embodiment of the present invention the definition of locations is defined in the centralized database as a place where shipments originate from, pass by or terminate at.

In an embodiment of the present invention the definition of locations is defined in the centralized database such that one or more transceivers can be assigned to the location.

In an embodiment of the present invention the information to describe a location can be associated to that location.

In an embodiment of the present invention the wireless loggers communicate with transceivers and offload accumulated measurement data from memory while in the vicinity of a transceiver.

In an embodiment of the present invention the wireless loggers resend data to transceivers in the event that the wireless logger detects that data was not successfully delivered to the transceiver.

In an embodiment of the present invention the wireless loggers terminate communication and accumulate measurement data in memory while not in the vicinity of a transceiver.

In an embodiment of the present invention the user data can be accessed by user for from the (in the) centralized database for analysis.

In an embodiment of the present invention a communication protocol between wireless loggers and transceiver allows one or many wireless loggers to communicate wirelessly with one or many transceivers before, during or after transportation.

In an embodiment of the present invention each wireless logger communicates wirelessly with only one transceiver at the time.

In an embodiment of the present invention a communication protocol between wireless loggers and transceiver allows a transceiver to communicate information relating to measurement logs and other information, from the wireless loggers to a centralized database system.

In an embodiment of the present invention a process in the centralized database monitors ongoing shipments and determines if wireless loggers linked to a shipment have reached to a transceiver associated with the destination location.

In an embodiment of the present invention the centralized system can distinguish between two locations which are close to each other, in the event that a wireless logger communicates unexpectedly through a transceiver at a location which is close by the destination location, but not assigned to that location.

In an embodiment of the present invention a wireless logger enters a new location with a transceiver configured for that new location, comprises the steps of;
assigning a location to a transceiver in the centralized database,
sending a location ID to the transceiver from the centralized database,
when the location ID stored in the transceiver does not match the current location ID of the logger, it indicates that the logger is entering a new location and then the transceiver creates an event, and
updating the location ID of the wireless logger each time it enters the new location by communicating a new location ID to a wireless logger and storing it in the memory of the wireless logger each time the wireless logger enters a different location.

In an embodiment of the present invention the reception of an event in the centralized database initiates a verification process for identifying if the shipment has arrived to its destination location by comparing the location from which the event for the wireless logger was issued to the location information for that shipment in the centralized database, and where no action is taken if the wireless logger is not at the destination location, and a delivery of the shipment is verified and a closure process for the shipment is initiated if the event comes from the destination location.

In an embodiment of the present invention more than one wireless logger is associated with a shipment and an event for each of the wireless loggers must be received in the centralized database for the shipment to be closed.

In an embodiment of the present invention the first data comprises reference parameters to be compared to the second and third data before closing the shipment.

In an embodiment of the present invention the transceiver unit and the one or more wireless data-logger is the same unit and is able to collect and transmit data before, during and after shipment.

In an embodiment of the present invention the first data is selected from, but not limited to an identification of the specific shipment, identification of one or more wireless sensory logger associated to the shipment, a reference to the receiving location of the shipment, desirable condition of the item with respect external factors or parameters during the shipment such as, but not limited to temperature, humidity, light intensity, digital status, frequency, width, height, speed, gas levels, electrical voltage, electrical current, pressure, vibration, acceleration, resistance, capacity, inductance.

In an embodiment of the present invention the second and third data is location data created before, during and after the shipment.

In an embodiment of the present invention the second and third data is data relating to desirable condition of the item with respect to external factors or parameters during the shipment such as, but not limited to temperature, humidity, light intensity, digital status, frequency, width, height, speed, gas levels, electrical voltage, electrical current, pressure, vibration, acceleration, resistance, capacity, inductance, created by the one or more wireless data-logger.

In an embodiment of the present invention the third data is location data confirming that the one or more wireless data-logger has reached a location.

In an embodiment of the present invention the location data is GPS data, cellular network position data, wireless network position data, IP network position data.

In an embodiment of the present invention closing a shipment comprises the steps of:
comparing the second data collected during the shipment to reference parameters in the centralized “online” database, said reference parameters being part of the first data,
deciding if the shipment has arrived to the correct receiving location by comparing the first data to the third data.

In an embodiment of the present invention the shipment is closed if the second data collected during the shipment is within reference parameters set for the shipment, but the shipment is not closed if the second data collected during the shipment does not fall within reference parameters set for the shipment.

In an embodiment of the present invention the at least one wireless data- logger measures and stores (logs) sensory data, being the second data, into a memory of the at least one wireless, data-logger.

In an embodiment of the present invention the at least one wireless data-logger has a unique identification number.

In an embodiment of the present invention the transceiver unit comprises a unique identification number, a location id, which references a location definition, generates location events when wireless loggers communicate with the transceiver, and sends sensory data and location events from a wireless data-logger to the centralized database.

In an embodiment of the present invention means is provided for allowing communication of sensory data between the at least one wireless data-logger and the transceiver unit.

In an embodiment of the present invention an event is created in the system to indicate that the shipment has arrived to this location. When one or more wireless loggers, which are embedded in a shipment for monitoring purposes, arrive at a location or comes within the vicinity of it, the event is created, but the event can originate in different parts of the system such as 1) in the centralized system, where the knowledge of which transceiver is at which location is used to know at which location each wireless logger is; 2) in the transceiver, where the unique location id, stored in the transceiver, is used to create an event and let the system know at which location the wireless logger was arriving to; or 3) in the wireless logger, where user action is used to trigger an event to be sent from the wireless logger, including a unique location ID. This event represents the process of a wireless logger moving from one location to another location, which may or may not be the destination location. The centralized database then, based on this information, decides whether the shipment has arrived at the destination location or not.

In the present context the term “transceiver unit” refers to a transceiver module which is positioned at the destination location and/or in the transport vehicle used to ship the items to be monitored. The transceiver unit has a unique ID which identifies it from other transceivers, where the unique ID serves a purpose to distinguish between transceivers both on a physical location and in a centralized database system. The transceiver unit is also a device which communicates with wireless loggers in a wireless manner and delivers logged measurements to a database. The Transceiver can receive real-time data, accumulated measurement logs, settings, events and configuration from a wireless logger, process the information, buffer it, and transmit it to the centralized database via an network connection (GPRS, WiFi, LAN, Ethernet or other network connection). Furthermore, the transceiver can transmit configuration parameters and/or commands to all wireless loggers on a network or a specific wireless logger. The configuration can either have origin in the centralized system, generated by the user or the system, or automatically in the transceiver for management purposes. Wireless data-loggers, as defined herein, can be implemented into the transceiver. Transceivers mediate in an automatic manner, when wireless data-loggers connect to a new location. Then events are issued to the centralized database to inform it that that specific wireless logger had changed location.

In the present context the term “wireless data-logger”, “wireless logger” and “wireless sensory logger” refers to devices having ,a sensor to measure environmental conditions which are of relevance to the user and/or the system, processor, a wireless communication module and memory. The sensor logs measurements into memory, communicates and transmits logged measurements to a centralized online database through a transceiver, once he is in range for wireless communication.

In the present context the term “location” refers to geographical location and location data based thereon. The location data can contain references to up to a number of transceiver. Shipment location relates to the location where the shipment is sent from and receiving location or destination location refers to the end-point of the shipment. In embodiments of the present invention location data may be collected through a network for geographical positioning, e.g. GPS or mobile phone network. Therefore locations for the route of the shipment can be recorded.

In the present context the term “automatic closure” and “to close a shipment” refers to the process of automatically estimating whether a shipment has been received and that the condition of the shipment during transportation was within system or user specified limits (reference values). The term “to close a shipment” therefore refers to the process of utilizing location information, which is sent from transceivers at the destination location to the centralized online system (database) and compared to a shipment information registry, issued when a shipment is initiated, to estimate weather the shipment has arrived to a correct location. This gives users feedback, and optionally performs analysis on the shipment.

In the present context the term “reception” and “delivery” refers to the process of receiving a shipment which includes a wireless data-logger at a destination location.

In the present context the term “environmental condition” refers to measured values or data acquired by a sensor, which describe the condition of environment at the wireless logger location, inside it or where the sensor for example measures temperature, humidity, light intensity, digital status, frequency, width, height, speed, gas levels, electrical voltage, electrical current, pressure, vibration, acceleration, resistance, capacity, inductance etc.

In the present context the term “shipment definition” is a definition of a chain-monitoring shipment containing ID reference to one or more wireless data-loggers, a reference to a destination location and a reference to the shipment. Furthermore, it can contain information on the origin location, time of shipping, expected time of delivery, parameters which describe the necessary condition limits during shipment etc.

In the present context the term “distribution network” refers to geographical positions which shipments are sent within, consisting of places of origin and destination and means to transport.

In the present context the term “data” refers to the following, but not limited to; shipment definitions stored in the centralized system, location definitions stored in the centralized system, information for hardware units, such as transceivers and wireless data-loggers, stored in the centralized system, real-time and logged environmental measurements sent from a wireless data-logger through a transceiver to the centralized system, events, which may originate in either the wireless logger, transceiver or the centralized system, which describe a certain activity of a certain wireless logger such as; a wireless logger entering a new location, a wireless logger leaving a location, a wireless logger indicating fault, a wireless logger indicating that an environmental measurement has exceeded a specified limit.

In the present context the term “data analysis” refers to the process of estimating the status of a shipment from accumulated measurement data and user and/or system data and by comparing this data to reference values (data) defined for the shipment.

In the present context the term “status of shipments” indicates at what place in the distribution network the shipment is, and the condition of the shipment in terms of analyzed data, compared to parameters (reference values).

In the present context the term “vehicle” refers to all devices designed to transport goods or items such as bicycles, cars, motorcycles, trains, ships, boats and aircrafts.

In an embodiment of the present invention statistical analysis may be performed on the shipment to estimate if it can be closed or not when a shipment has been delivered. The system closes the shipment if the shipment measurements fulfil criteria set by the user for the condition of the shipment during transportation. When statistical analysis is performed, each measurement, measured by the sensor during shipment, is compared to the limits defined in the shipment data registry. Verification is done to ensure that data has been delivered from the wireless logger for the duration of the shipment, from shipping date to delivery date. The shipment may be closed only when data has been delivered and if the condition during shipment has been within user specified limits.

In the present context the term “delivered” refers to the event where the shipment has arrived at its destination location and the centralized database has classified the shipment as being on its destination location.

### DESCRIPTION OF THE DRAWINGS

The present invention will now be disclosed in reference to the drawings illustrating the specific embodiments of the invention. The specific embodiments disclosed herein should not be limiting to the invention as described in the claims and the description.

FIG. 1 shows interaction between software and hardware and some of the features which are necessary for automatic closure.

FIG. 2 shows the message system of the present invention and the flow of operation in the centralized system.

FIG. 3 shows the online user interface in an embodiment of the present invention.

FIG. 4 shows a diagram of an analysis process of accumulated measurement data compared to user and/or system specified parameters for a shipment.

FIG. 5 shows an overview of the system of the invention.

### DETAILED DESCRIPTION OF PREFERRED EMBODIMENTS

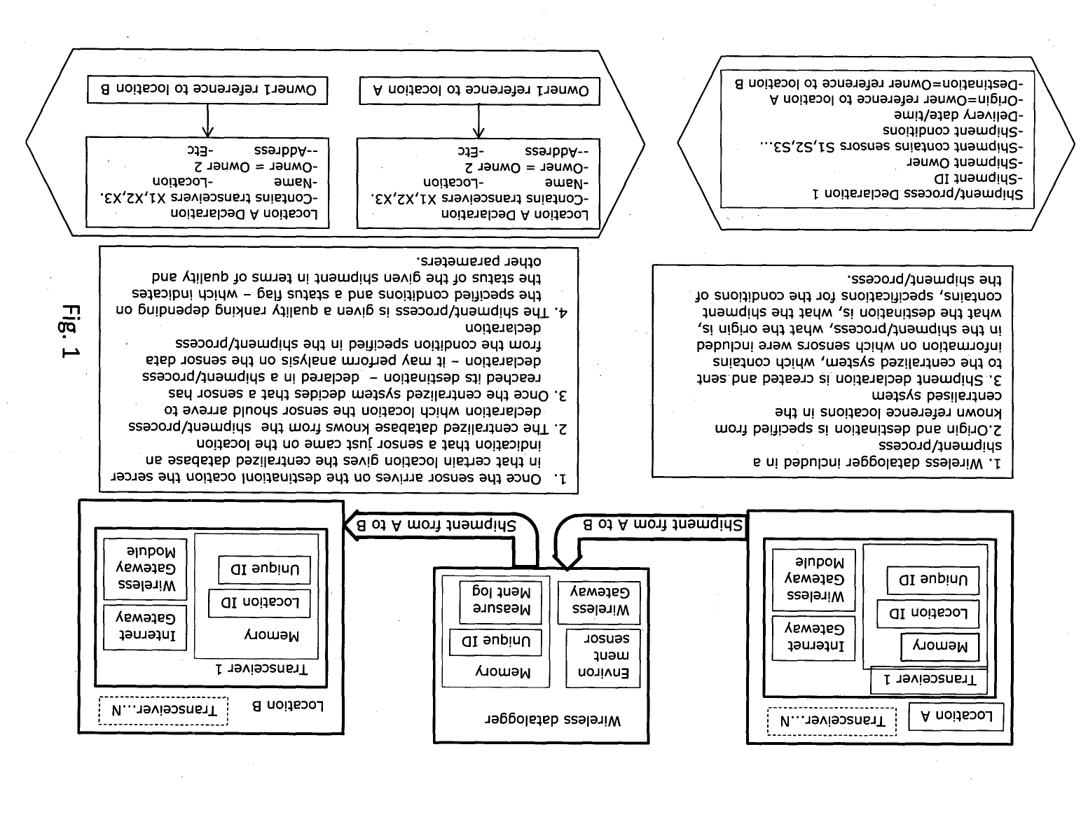

FIG. 1 shows interaction between software and hardware and some of the features which are necessary for automatic closure. At each location, or in the shipment itself, there is a transceiver, comprising of processor, memory, means to communicate with a wireless data-logger and centralized “online” database. The transceiver is uniquely identified in the system by its transceiver ID. A location ID is a reference to which location the transceiver is located on and can either be configured by the system or automatically acquired from geographical data. If a transceiver is in a vehicle or a shipment, the location ID is automatically changed by the system. If a wireless data-logger communicates with a transceiver on a location, events are sent to the centralized system. If a location event indicates that a certain wireless logger has arrived to its destination location, a “reception” process is started in the centralized database where shipment is analyzed according to user and system specified parameters. If the data, gathered for the shipment, meets the specified parameters the shipment is automatically “closed”. A location can be defined from geographical data and/or one or more transceivers. Sensor consists of a processor, memory to store software, measurement log, configuration information, an environmental sensor and a wireless gateway which communicates with a transceiver.

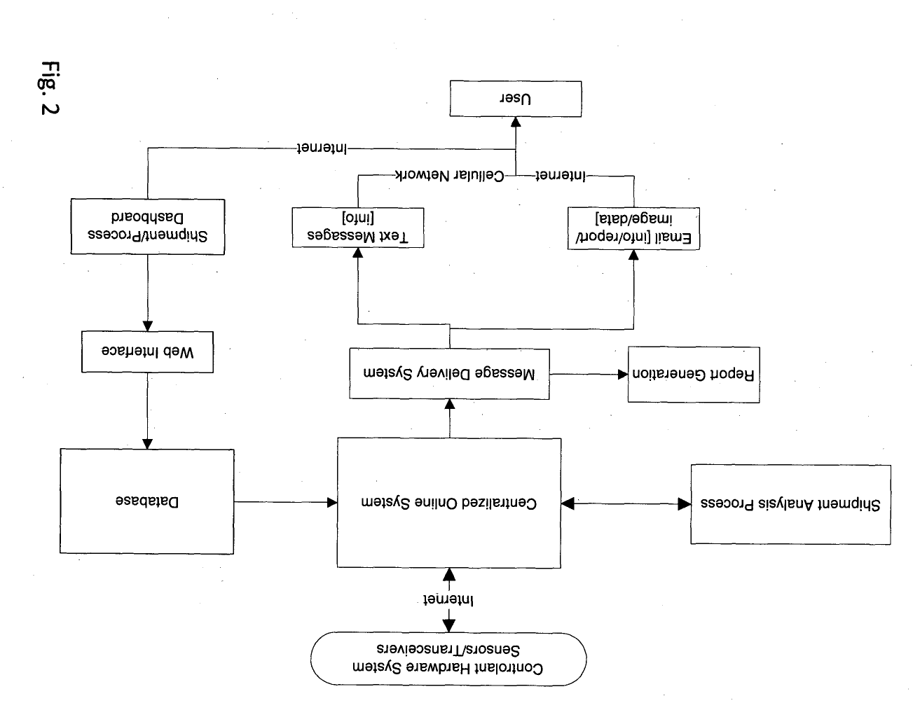

FIG. 2 describes the flow of operation in the centralized system. Data, events and other information flow from transceivers and wireless data-loggers over a network connection.

Measurement data and events which are received by the centralized database are stored in a database, which is accessible by users and internal systems. When an event indicates that a wireless data-logger, defined to be in a certain shipment, arrives to a destination location defined in the same shipment an automatic analysis process is initialized. The analysis process uses user and/or system specified parameters to estimate the status of the shipment. The status of the shipment can depend on environmental conditions, such as temperature, humidity, pressure, vibration etc., during transportation as well as system data, such as data quality, duration of shipment, time of day etc. Once a status has been set by the analysis process, the shipment is either “closed” or not. If the shipment is “closed”, the user is not required to view and analyze the shipment. If not, the user may need to inspect and take necessary action according to the nature of the status, contact people responsible, stop manufacturing or distribution processes etc. Automatic message delivery can be requested by the user. Reports are generated and sent once shipment has arrived and/or once analysis has been made to the shipment. Reports can be in the form of a data file, a text file, pdf report, image or data and sent to the user with email, text message. The user has access to all of his shipments and their status via an on-line dashboard. Rules and measurement types used for automatic shipment analysis can vary between sectors (pharmaceutical, food, industry etc)

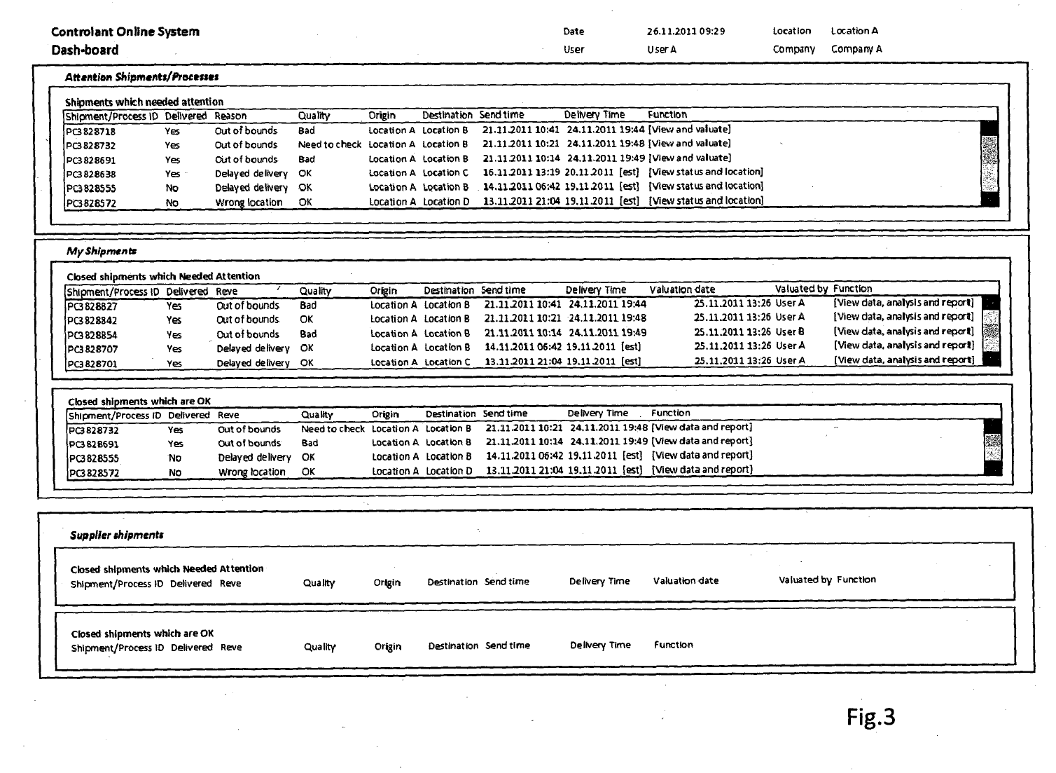

FIG. 3 shows a dash-board being the online interface, where the user can get an overview of the status of shipments.

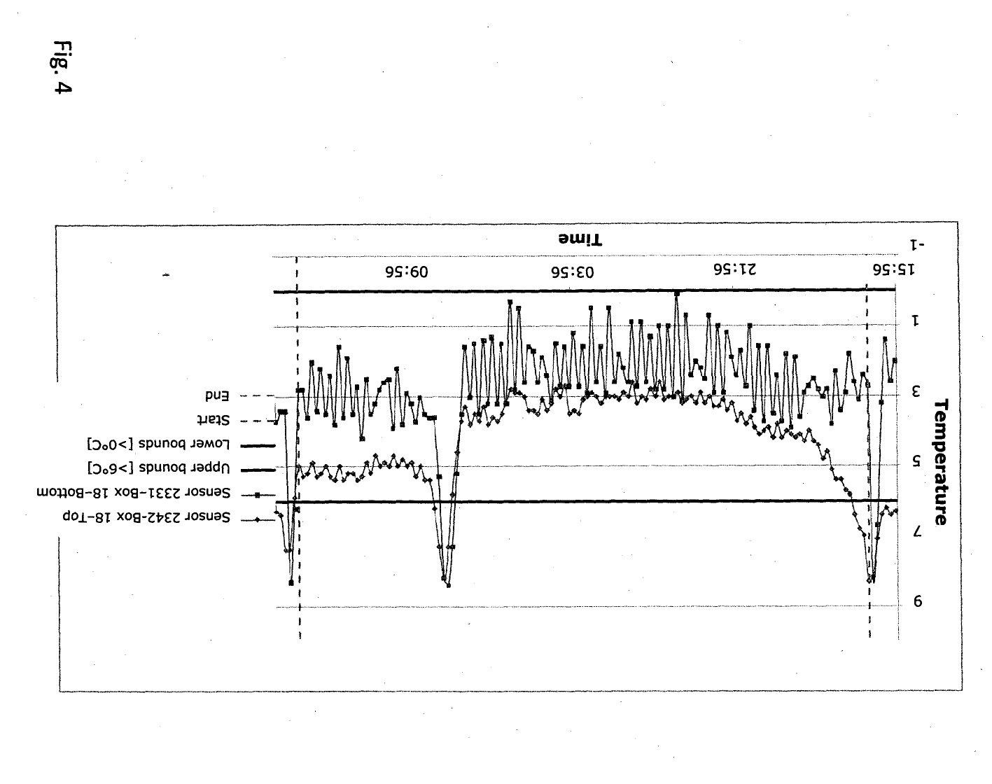

In FIG. 4 an analysis process of one shipment is shown as an example of one embodiment according to the present invention. Once a shipment has arrived to its destination location, an analysis is performed on accumulated measurement data and compared to user and/or system specified parameters. In this example the shipment parameters are upper and lower temperature limits, out-of-bounds time-limits, expected delivery time and more. FIG. 4 shows an example of data from a shipment with two temperature sensors, where temperature limits have been set to 0° C. and 6° C. As can be seen, the temperature goes above the upper temperature limit and if the duration of temperature outside of the limits exceeds the time set by the user, the analysis process would decide not to close the shipment. The decision to “close” shipment, therefore, depends on various factors—depending on user needs.

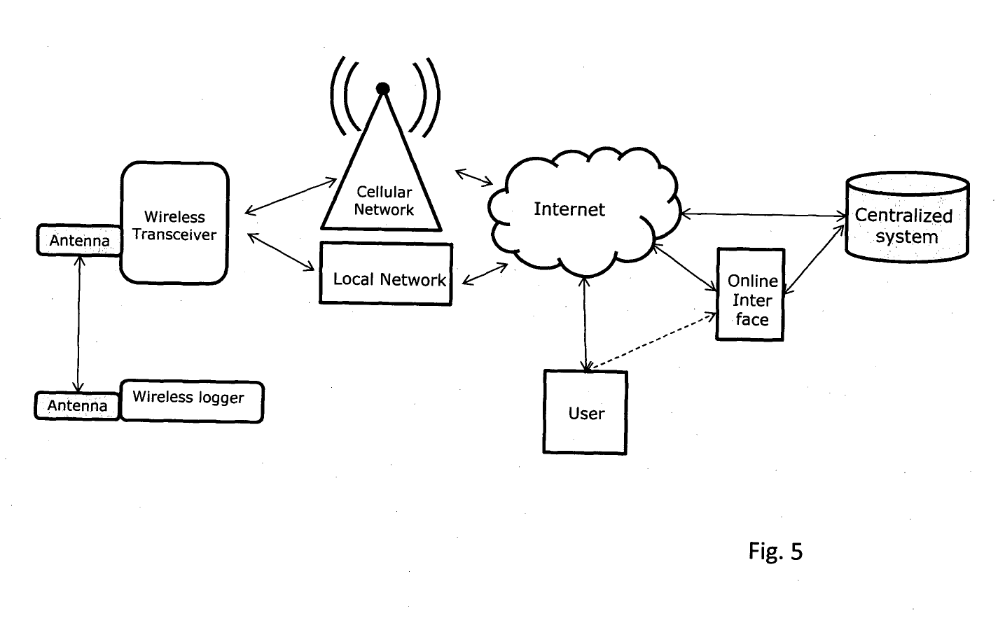

FIG. 5 shows how a wireless data-logger communicates real time status of environmental conditions to a transceiver while wireless data-logger is within reach of a transceiver for wireless communication. It can measure and stores status of environmental conditions in memory and send the stored measurements to a transceiver when within reach for wireless communication. The wireless data-logger can receive configuration parameters, commands, software updates or other information from a transceiver, which may have origin in the transceiver itself or the centralized system. A transceiver is a device which communicates wirelessly with wireless data-loggers. The Transceiver can receive real-time data, accumulated measurement logs, settings, events and configuration from a wireless data-logger, process the information, store it in memory, and transmit the data to the centralized database via an network connection (GPRS, WiFi, LAN, USB, Ethernet or other network connection). The transceiver can transmit configuration parameters and/or commands to all wireless loggers on a network or to a specific wireless logger. The configuration can either have origin in the centralized system, generated by the user or the system, or automatically in the transceiver for management purposes. The centralized database can send configuration parameters, commands, software updates and other information to a transceiver. Data, measurements, events and other information, is stored in a database upon reception by the centralized system. The data can be accessed by users through an online interface. Analysis can be performed on the data by the centralized system.

In the following examples different scenarios and aspects of the present invention are further outlined:

In one example, a user wants to record temperature of a shipment while in transport to estimate the quality of transportation and verify that the shipment was within a specific temperature range. The user takes a wireless logger which he owns and is not being used in another shipment. He creates a shipment data registry in a web-based interface by selecting the desired wireless logger IDs, the desired destination location and, optionally, the preferred criteria for measurements and the origin destination.

Then, the user creates a shipment by using data from centralized ordering and packaging systems and by using a bar-code hand scanner to read serial IDs of wireless loggers. This process is more automated than the web-based interface method, and can be integrated to ordering and packaging systems owned and operated by the user.

Next, the user creates a shipment by using a specific software, including but not limited to software for desktop computers, laptops and a mobile application. The software can utilize reading devices such as; barcode scanners, NFC readers, RFID readers to read serial IDs of wireless loggers, shipments, ordering numbers, destination locations and other information.

Finally, one or more buttons on the wireless logger is used to indicate a start/stop event for the closure process.

Examples for uses of how shipments are monitored: In the centralized database a software program is constantly being run to monitors data relating to on-going or “open” shipments. Each time it is run, it will scan through data relating to shipments and estimate if it has arrived at the destination location. If the shipment monitor finds no data to indicate that a specific shipment has arrived at its destination location, the monitor does nothing. If it detects, e.g. from events, that the shipment has arrived to its destination an analysis will be performed on the measurement data over the shipment period to ensure that all data has been delivered and that measurements are within user specified criteria. A decision on whether to close a shipment or not is based on this analysis.

Real time monitoring: The centralized database can do a real-time monitoring on received data. As measurements are delivered to the centralized system, the system can analyze it and compare it to the user specified criteria on the shipment conditions. If a deviation in measurements is detected, alerts are sent to specified users. The system can also do an analysis on all or specific parts of the transportation route. These parts can be estimated from the location events which indicate at which location the wireless logger was at which location.

Registering shipment data: A shipment is created when data registry, containing necessary information on the shipment, its wireless loggers and other data, is created and stored in the centralized system. A user can create this data by using software tools e.g. in a web-interface or by customized software tools. This procedure can also be automated and integrated to packaging and ordering systems owned by the user.

Use of shipment data: When shipments travel between locations which are defined in the centralized system, events are created and sent to the centralized database which indicates that the shipment is now at a certain location. A process monitors the events and compares to on-going shipments which have been stored in the centralized system. If an event from a wireless logger within a shipment has arrived at the destination location, a closure process is initiated.

### Technical Details:

Wireless loggers log measurements regularly into memory, where the interval can be configured into each wireless logger unit. Once a wireless logger comes into the vicinity of a transceiver and is able to initiate wireless communication with the transceiver, the transceiver either allows or disallows that wireless logger to begin communication. In, the case where the transceiver allows the wireless logger to begin communication, the wireless logger begins to transmit log of measurements to the transceiver. The transceiver then transmits the data to the centralized system. During the phase when the wireless logger is initiating communication with the transceiver, the transceiver checks if the wireless logger has previously been at the location which the transceiver is assigned to. If the transceiver detects that the wireless logger is new on that location, the transceiver will issue an event to the centralized database which is then used to mark the shipment as delivered and initiate a closure for the shipment.

A location is defined in the centralized database system. Transceivers are linked to a location in the centralized database where multiple transceivers can be configured to the same location. As an alternative to using events to estimate if a wireless logger has arrived to a location, the centralized database can use information which is created in the centralized database when a wireless logger switches locations. In the case where multiple locations are in the same area and wireless loggers connect to transceivers who do not belong to the destination location, the centralized database can close the shipment based on location information from both the destination location and the location in which the transceiver which has connect to the wireless logger is located, along with geographical information data for each location. The system thus supports two locations which are close to each other to use the same transceiver for estimating a delivery.

### Scenarios:

In the first scenario, a shipment is sent from location A, which may or may not contain a transceiver, to location B which contains a transceiver and the shipment does not come into the vicinity of a transceiver during transportation. In this case the data is logged into memory of the wireless logger during transportation. Once the shipment arrives at the destination location, the system generates an event, as described in the text above. Once the shipment has been classified as delivered, the closure process decides whether or not the shipment may be closed.

In the second scenario, a shipment is sent from location A, which may or may not contain a transceiver, to location B which contains a transceiver and the shipment comes in the vicinity of one or more transceivers during transportation, either in the vehicle or on stationary locations or both. In this case the measurements are logged into memory of the wireless logger during transportation. When the wireless logger comes into the vicinity of transceivers during transportation, logged measurement data is sent from the wireless logger to the transceiver, which transmits the data to the centralized system. During this process, an event is sent to the centralized system. Since the wireless logger is at a location which was not defined as the destination location, the shipment is not classified as delivered and may therefore not go through the closure process. As soon as the shipment arrives at the destination location and loggers start to communicate with transceivers, the process may be initiated.

1. A system to maintain real-time monitoring of numerous shipments at once, the system comprising:
a network of transceivers, wherein where each transceiver is assigned to a location;
one or more wireless loggers assigned to each shipment, said wireless loggers comprising:
a wireless communication module,
a processor,
a sensor configured to monitor conditions during the shipment and generate measurement data, and
memory configured to store the measurement data and
a centralized database system configured to:
receive and store measurement data,
store information to define locations and transceivers associated to said locations within the said system, and
store user selected reference values for said conditions during transport of the shipment;
wherein each transceiver is configured to communicate with one or more wireless loggers and wherein automatic communication of data between wireless loggers, transceivers and centralized database is performed by a communication protocol; and
wherein the system is configured to close closing each shipment by performing the following steps:
verifying verification in the centralized database that a wireless logger in said shipment has communicated with a transceiver at a destination location,
comparing data sent from wireless loggers through a transceiver before, during or after transportation to the user selected reference values in the centralized database for the shipment,
determining if the data for the shipment falls within the predetermined reference values for the shipment,
updating shipment information with information from the analysis process, and
closing the shipment if the data for the shipment falls within the predetermined reference values for the shipment,
wherein the steps for closing a shipment are performed automatically and wherein an event is created when a wireless logger starts to communicate with a transceiver at a location other than its previous location.

2. A system according to claim 1, wherein the transceiver creates the event and generates data comprising this information, storing a new location ID in the memory of the wireless logger and communicating the event to the centralized database.

3. A system according to claim 1, wherein the event is created when in the centralized database when a wireless logger starts to communicate to a transceiver at a location other than its previous location, said event being created as a result of a data comparison and/or data analysis determining if the shipment is at a destination location.

4. A system according to claim 1, wherein the network of transceivers comprises transceivers located at two or more locations selected from
shipping location,
intermediate location, and
receiving location.

5. A system according to claim 1, wherein the definition of locations is defined in the centralized database as a place where shipments originate from, pass by or terminate at.

6. A system according to claim 5, wherein the definition of locations is defined in the centralized database such that one or more transceivers can be assigned to the location.

7. A system according to claim 5, wherein the information to describe a location can be associated to that location.

8. A system according to claim 1, wherein the wireless loggers communicate with transceivers and offload accumulated measurement data from memory while in the vicinity of a transceiver.

9. A system according to claim 1, wherein the wireless loggers resend data to transceivers in the event that the wireless logger detects that data was not successfully delivered to the transceiver.

10. A system according to claim 1, wherein the wireless loggers terminate communication and accumulate measurement data in memory while not in the vicinity of a transceiver.

11. A system according to claim 1, wherein user data from the centralized user database can be accessed by users for analysis.

12. A system according to claim 1, wherein a communication protocol between wireless loggers and transceiver allows one or many wireless loggers to communicate wirelessly with one or many transceivers before, during or after transportation.

13. A system according to claim 12, wherein each wireless logger communicates wirelessly with only one transceiver at a time.

14. A system according to claim 1, wherein a communication protocol between wireless loggers and transceiver allows a transceiver to communicate information relating to measurement logs and other information, from the wireless loggers to a centralized database system.

15. A system according to claim 3, wherein a process in the centralized database monitors ongoing shipments and determines if wireless loggers linked to a shipment have reached to a transceiver associated with the destination location.

16. A system according to claim 1, wherein the centralized system can distinguish between two locations which are close to each other in the event that a wireless logger communicates unexpectedly through a transceiver at a location which is close by the destination location but not assigned to that location.

17. A system according to claim 2, wherein the event creation, when a wireless logger enters a new location with a transceiver configured for that new location, comprises the steps of:
assigning a location to a transceiver in the centralized database,
sending a location ID to the transceiver from the centralized database,
when the location ID stored in the transceiver does not match the current location ID of the logger, indicating that the logger is entering a new location and then the transceiver creates an event, and
updating the location ID of the wireless logger each time it enters the new location by communicating a new location ID to a wireless logger and storing it in the memory of the wireless logger each time the wireless logger enters a different location.

18. A system according to claim 17, wherein the reception of an event in the centralized database initiates a verification process for identifying if the shipment has arrived at its destination location by comparing the location from which the event for the wireless logger was issued to the location information for that shipment in the centralized database, and wherein:
no action is taken if the wireless logger is not at the destination location, and
a delivery of the shipment is verified and a closure process for the shipment is initiated if the event comes from the destination location.

19. A system according to claim 18, wherein more than one wireless logger is associated with a shipment and an event for each of the wireless loggers must be received in the centralized database for the shipment to be closed.

20. A system according to claim 18, wherein more than one wireless logger is associated with a shipment and only one event for one of the wireless loggers must be received in the centralized database for the shipment to be closed.
